(19) United States
(12) Patent Application Publication
(10) Pub. No.: US 2025/0332840 A1
(43) Pub. Date: Oct. 30, 2025

(54) PRINTING CONSUMABLE ARTICLE MANAGEMENT IC CHIP, MANAGEMENT DEVICE, AND NON-TRANSITORY COMPUTER READABLE STORAGE MEDIUM

(71) Applicant: BROTHER KOGYO KABUSHIKI KAISHA, Nagoya (JP)

(72) Inventor: Shumei MORI, Ichinomiya (JP)

(21) Appl. No.: 19/261,584

(22) Filed: Jul. 7, 2025

Related U.S. Application Data
(63) Continuation of application No. PCT/JP2023/000269, filed on Jan. 10, 2023.

(51) Int. Cl. B41J 2/175

(52) U.S. Cl. CPC B41J 2/17546; B41J 2/17506; B41J 2/17566; B41J 2002/17569

(57) ABSTRACT

A management device for an IC chip to be provided to a consumable article that is to be attached to or supplied to a printing device. The management device includes a controller. The controller is configured to: acquire information on the number of reuses of the IC chip which is stored in an IC storage included in the IC chip; determine whether the number of reuses is equal to or greater than a predetermined number of times based on the acquired information; and restore, in the IC storage, information obtained by counting up the number of reuses when the controller determines that the number of reuses is less than the predetermined number of times.

### REFERENCE TO RELATED APPLICATIONS

This is a continuation application of International Application No. PCT/JP2023/000269 filed on Jan. 10, 2023. The entire contents of the aforementioned application is incorporated herein by reference.

### BACKGROUND ART

In a related art, an ink cartridge provided with an IC chip in which predetermined information is stored. The related art proposes removing an IC chip from a collected ink cartridge, performing predetermined cleaning on the IC chip, and then reusing the IC chip that has passed an electrical characteristic inspection.

However, in the case in the related art, it is necessary to perform the electrical characteristic inspection on all of the collected IC chips, and thus a processing load is large when the IC chips are reused. Such a situation is not limited to the IC chip provided to the ink cartridge, and the same applies to any IC chip provided to a consumable article that is to be attached to or supplied to a printing device.

### SUMMARY

Therefore, an object of the present disclosure is to provide a printing consumable article management IC chip, a management device, and a non-transitory computer readable storage medium capable of reducing a processing load when an IC chip to be provided to a consumable article is reused.

A management device for an IC chip to be provided to a consumable article that is to be attached to or supplied to a printing device. The management device includes a controller. The controller is configured to: acquire information on the number of reuses of the IC chip which is stored in an IC storage included in the IC chip; determine whether the number of reuses is equal to or greater than a predetermined number of times based on the acquired information; and restore, in the IC storage, information obtained by counting up the number of reuses when the controller determines that the number of reuses is less than the predetermined number of times.

Accordingly, it is possible to easily determine whether the IC chip can be reused based on whether the number of reuses of the IC chip is equal to or greater than the predetermined number of times. Therefore, it is not necessary to perform an electrical characteristic inspection on all of the collected IC chips, and it is possible to reduce a processing load required for reuse.

According to the present disclosure, it is possible to reduce a processing load for reusing an IC chip to be provided to a consumable article.

### BRIEF DESCRIPTION OF THE DRAWINGS

FIG. 1 is a schematic diagram illustrating a part of a reuse cycle of a printing consumable article management IC chip 1 which is configured to include the IC chip and a management device according to the present disclosure.

FIG. 2A is a block diagram illustrating a configuration of the IC chip, and FIG. 2B is a block diagram illustrating a configuration of the management device.

FIG. 3 is a flowchart illustrating a reuse cycle of the IC chip which is achieved by the management device.

FIG. 4 is a flowchart illustrating a reuse process executed by the management device.

FIG. 5 is a flowchart illustrating the reuse process executed by the management device.

FIG. 6 is a flowchart illustrating the reuse process executed by the management device.

FIG. 7 is a flowchart illustrating the reuse process executed by the management device.

FIG. 8 is a flowchart illustrating the reuse process executed by the management device.

### DESCRIPTION

Hereinafter, an embodiment according to the present disclosure will be described in detail with reference to the drawings. In the following description, the same or corresponding elements are denoted by the same reference numerals in all the drawings, and redundant description thereof is omitted.

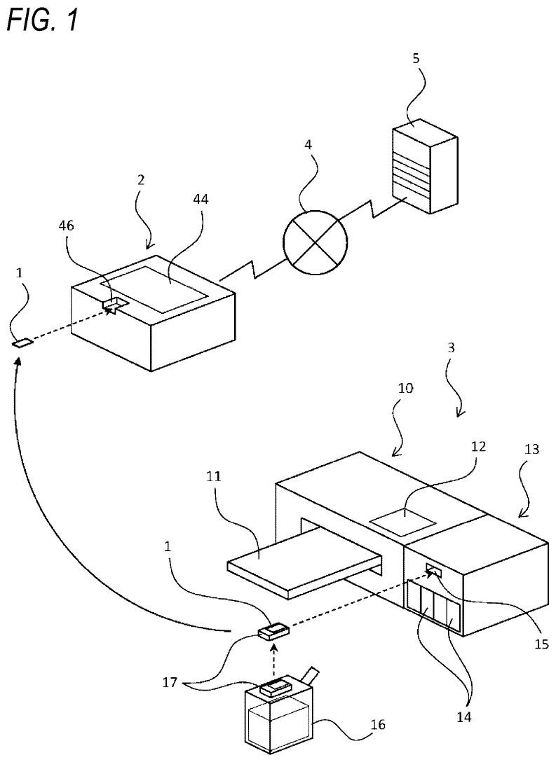

FIG. 1 is a schematic diagram illustrating a part of a reuse cycle of a printing consumable article management IC chip 1 (hereinafter simply referred to as “IC chip 1”) which is configured to include the IC chip 1 and a management device 2 according to the present disclosure. As illustrated in FIG. 1, the IC chip 1 is provided to a consumable article of a printing device 3 to be used by a user. The consumable article is used to enable the printing device 3 to exhibit a function of the printing device 3, and is attached to or supplied to the printing device 3. Typically, as the consumable article, a coloring material such as ink or toner, a pretreatment liquid, a post-treatment liquid, a print head that ejects ink, a cleaning member such as a wiper which cleans the print head, a cleaning liquid that cleans the print head or the cleaning member are exemplified. The consumable article is not limited to a consumable article whose use period is shorter than a product life of the printing device 3, and may be a consumable article whose use period is assumed to be equal to or longer than the product life of the printing device 3.

In FIG. 1, an ink jet printer is exemplified as the printing device 3, and ink used for image formation (printing) in the printing device 3 is exemplified as the consumable article. The printing device 3 illustrated in FIG. 1 includes a printing unit 10 and an ink supply unit 13. The printing unit 10 includes a platen 11 on which a recording medium is placed and which moves to a predetermined position for printing, an input and output unit 12 including a touch panel display or the like capable of inputting and outputting various kinds of information, and a print head that ejects ink onto the recording medium to form an image. The ink supply unit 13 includes a plurality of tanks 14 corresponding to ink colors. The ink stored in each of the tanks 14 is supplied to the print head.

Here, the tank 14 can be replenished with ink from an ink bottle 16 that is separate from the printing device 3. Such ink replenishment is performed by the user. The ink bottle 16 is provided for each type of ink. The user can purchase the ink bottle 16 filled with a necessary type of ink, for example, in an online store. The ink bottle 16 is provided with the printing consumable article management IC chip 1 according to the present disclosure.

In the example of FIG. 1, the IC chip 1 is attached to a chip holder 17, and the chip holder 17 to which the IC chip 1 is attached is detachably attached to a predetermined position of the ink bottle 16. Meanwhile, the ink supply unit 13 of the printing device 3 is provided with an insertion portion 15 for the chip holder 17. When supplying the ink to the tank 14, the user removes the chip holder 17 having the IC chip 1 from the ink bottle 16, inserts the chip holder 17 into the insertion portion 15, and then replenishes the tank 14 with the ink in the ink bottle 16.

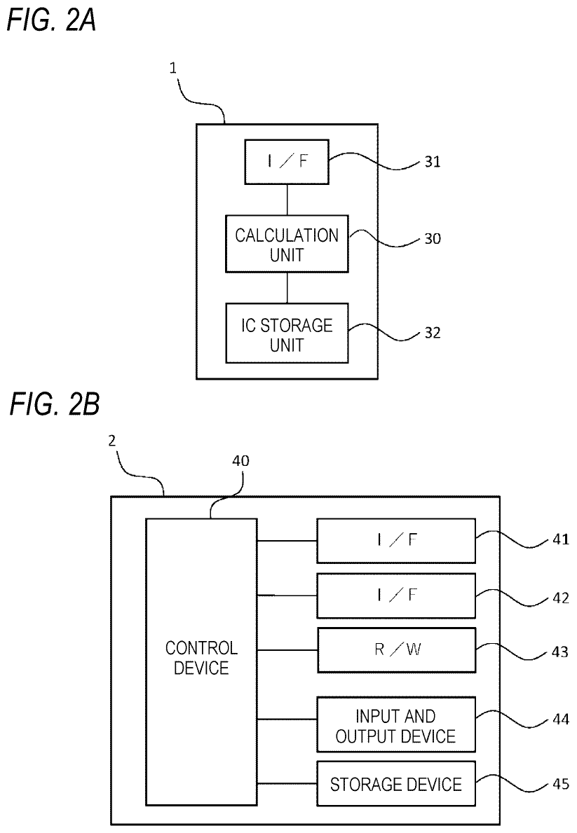

FIG. 2A is a block diagram illustrating a configuration of the IC chip 1. As illustrated in FIG. 2A, the IC chip 1 includes a calculation unit 30, an interface (I/F) 31, and an IC storage unit 32. The calculation unit 30 includes a circuit such as a micro processing unit (MPU) or a microcomputer. The interface 31 transmits and receives data to and from the outside in a wired or wireless manner. The IC storage unit 32 includes a nonvolatile storage element such as a NAND type flash memory, and stores data received via the interface 31 or deletes the stored data according to an instruction from the calculation unit 30. The calculation unit is an example of a calculator. The IC storage unit is an example of an IC storage.

The IC storage unit 32 stores consumable article information on the consumable article provided with the IC chip 1. Therefore, as described above, when the chip holder 17 having the IC chip 1 is inserted into the insertion portion 15 of the printing device 3, the printing device 3 takes the consumable article information from the IC chip 1 and uses the consumable article information for managing the consumable article.

When the ink bottle 16 becomes empty, the IC chip 1 attached to the ink bottle 16 is collected by a predetermined collection company or the like. The collected IC chip 1 is managed for reuse. Therefore, in the reuse cycle illustrated in FIG. 1, the management device 2 that manages reuse of the IC chip 1 is provided.

FIG. 2B is a block diagram illustrating a configuration of the management device 2. As illustrated in FIG. 2B, the management device 2 includes a control device 40, an interface (I/F) 41,42, a reader and writer (R/W) 43, an input and output device 44, and a storage device 45. The control device 40 includes a circuit such as an MPU, and controls various operations of the management device 2. One interface 41 transmits and receives data to and from the interface 31 of the IC chip 1 in a wired or wireless manner.

As illustrated in FIG. 1, the management device 2 includes a loading portion 46 into which the IC chip 1 is to be loaded. When the IC chip 1 is loaded into the loading portion 46, the data can be transmitted and received between the IC chip 1 and the management device 2 via the interfaces 31 and 41. The other interface 42 transmits and receives data to and from another communication device such as a server 5 via a communication line 4 such as the Internet.

The reader and writer 43 is provided in the vicinity of the loading portion 46, sends a control signal and data to the IC chip 1 loaded in the loading portion 46, and writes (stores) and deletes data to and from the IC storage unit 32 according to an instruction from the control device 40. The input and output device 44 includes a touch panel display or the like, and is provided at a position where the user can directly operate the input and output device 44 in the management device 2 as exemplified in FIG. 1. The input and output device 44 allows an operator to input various kinds of information or outputs various kinds of information to the operator.

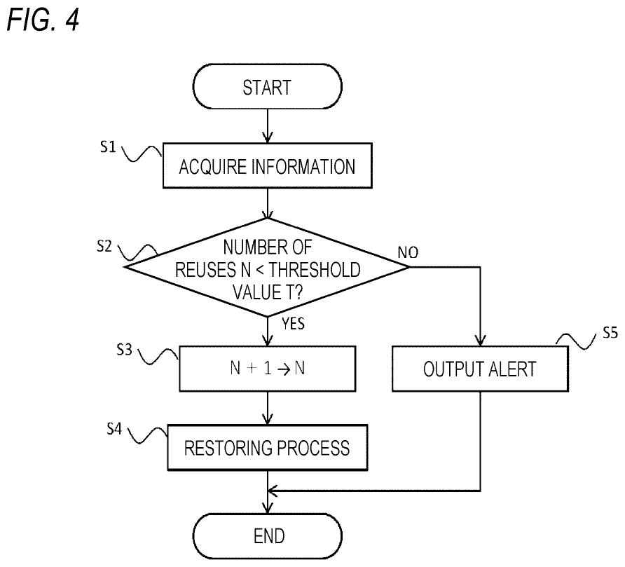

The storage device 45 is a storage unit including a read only memory (ROM), a random access memory (RAM), a hard disk drive (HDD), and the like. The storage device 45 stores a computer program necessary for the management device 2 to function, stores data generated by executing the computer program by the control device 40, and stores data acquired from the outside via the interfaces 41 and 42. That is, the management device 2 achieves various operations (functions) according to the present disclosure by executing the computer program stored in the storage device 45. A specific operation of the management device 2 will be described later with reference to FIGS. 4 to 8. The storage unit is an example of a storage.

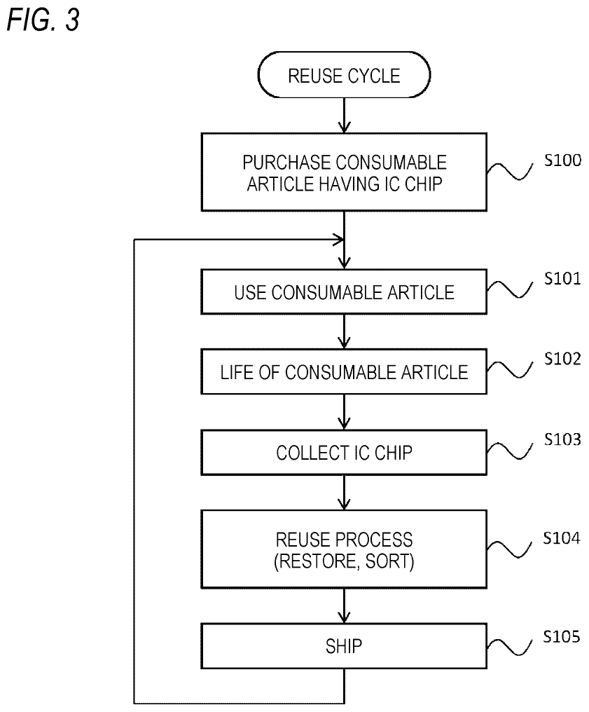

FIG. 3 is a flowchart illustrating the reuse cycle of the IC chip 1 which is achieved by the management device 2. Here, with reference to FIG. 1, the reuse cycle will be described by using the ink stored in the ink bottle 16 as the consumable article and focusing on the IC chip 1 provided in the ink bottle 16.

As illustrated in FIG. 3, in this reuse cycle, the ink bottle 16 having the IC chip 1 is purchased by a user (step S100). The user replenishes the tank 14 with the ink in the ink bottle 16 and uses the ink by, for example, printing an image (step S101). When the tank 14 is replenished with all the ink in the ink bottle 16, the ink bottle 16 becomes empty and reaches the end of its life (step S102). Next, the IC chip 1 is removed and collected from the ink bottle 16 that has reached the end of its life (step S103), and is sent to a management company. The IC chip 1 may be collected by the predetermined collection company or may be shipped to the management company by the user.

The IC chip 1 collected to the management company is subjected to a reuse process using the management device 2 (step S104). For example, the process is executed such as a process of updating predetermined information stored in the IC storage unit 32 of the IC chip 1 and restoring the information in the IC storage unit 32, or a process of sorting the IC chip 1 based on the information stored in the IC storage unit 32. Accordingly, the IC chip 1 collected after use is in a reusable state. Then, when the ink bottle 16 having the IC chip is purchased by any user, the ink bottle 16 having the IC chip 1 is shipped to the user (step S105) and used (reused) by the user (step S101).

Next, the reuse process executed in step S104 of the reuse cycle as described above will be described with reference to FIGS. 4 to 8. The reuse process is achieved by executing, by the control device 40 of the management device 2, the computer program according to the present disclosure stored in the storage device 45.

### First Example of Reuse Process

FIG. 4 is a flowchart illustrating a first example of the reuse process executed by the management device 2. As illustrated in FIG. 4, when the collected IC chip 1 is loaded into the loading portion 46 by the operator, the management device 2 acquires the predetermined information from the IC chip 46 (step S1). The information to be acquired includes information (for example, an ink color, a capacity of the ink bottle 16, and the like) on the consumable article provided with the IC chip 1, and information on the number of times (number of reuses) N in which the IC chip 1 is provided to the consumable article and used.

Since the IC chip 1 to which the reuse cycle is applied is in the reusable state, information on the consumable article to be used next is written in the IC storage unit 32. The writing of the information is executed by the calculation unit 30 in the IC chip 1 according to an instruction from the reader and writer 43 included in the management device 2. Therefore, the number of reuses of the calculation unit 30 of the IC chip 1, in other words, the accumulated number of times of writing to the IC storage unit 32 by the calculation unit 30 can be used as the “number of reuses N” of the IC chip 1 described above.

Next, the management device 2 determines whether the acquired number of reuses N is equal to or greater than a predetermined number of times (threshold value T) (step S2). The threshold value T is a value that limits the number of reuses of the IC chip 1, and can be appropriately set within a range in which the operation of the IC chip 1 can be guaranteed. For example, the threshold value T may be an upper limit value of the accumulated number of times of writing by the calculation unit 30 or a value obtained by subtracting a predetermined number from the upper limit value. The threshold value T can be set based on a specification of an element used in the IC chip 1, performance data obtained in advance, and the like.

If the number of reuses N is smaller than the threshold value T in step S2 (S2: YES), the management device 2 increments the number of reuses N acquired from the IC chip 1 by one (step S3), and restores information on the incremented number of reuses in the IC storage unit 32 of the IC chip 1 (step S4).

On the other hand, if the number of reuses N is equal to or greater than the threshold value T (S2: NO), the management device 2 outputs alert information to the input and output device 44 (step S5). The alert information is information indicating that the number of reuses of the IC chip 1 has reached the number of times at which the reuse should be restricted. The IC chip 1 for which the alert information has been output is not reused thereafter, and is discarded or the like.

According to the reuse process described above, the collected IC chip 1 after use can be reused within a range in which the operation of the IC chip 1 is guaranteed. Therefore, for example, it is sufficient to perform an electrical characteristic inspection on the IC chip 1 whose number of reuses N is determined to be smaller than the threshold value T in step S2, and thus it is not necessary to execute a process with a large load such as total inspection of the electrical characteristic inspection on the collected IC chip 1.

### Second Example of Reuse Process

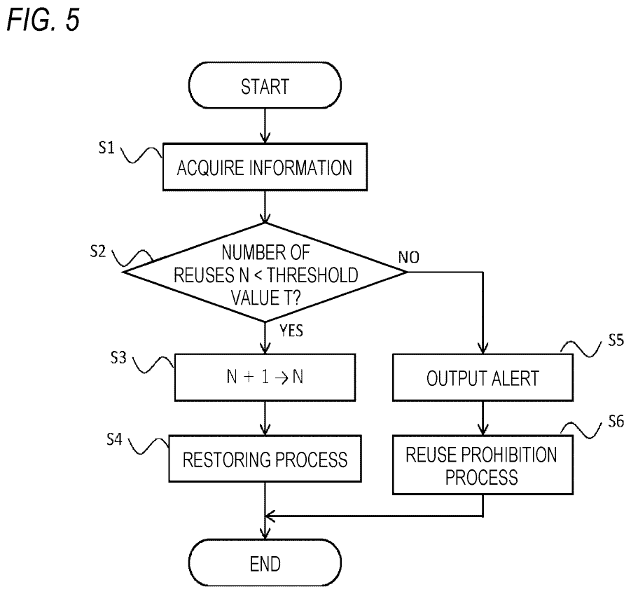

FIG. 5 is a flowchart illustrating a second example of the reuse process executed by the management device 2. The reuse process illustrated in FIG. 5 includes the steps S1 to S5 that are the same as those of the reuse process (first example) illustrated in FIG. 4, and includes step S6 that is not illustrated in FIG. 4. Therefore, only matters related to step S6 will be described here.

In the reuse process in FIG. 5, if the number of reuses N of the collected IC chip 1 is equal to or greater than the threshold value T (step S2: NO), an alert is output (step S5), and a reuse prohibition process (step S6) is executed on the IC chip 1. In the reuse prohibition process, for example, predetermined reuse prohibition information is stored in the IC storage unit 32 of the IC chip 1, or a process for setting the IC chip 1 to a reuse prohibition state is executed.

An example of the reuse prohibition information is information that displays a meaning of “reuse prohibition” on the input and output unit 12 of the printing device 3 when the IC chip 1 is attached to the consumable article again and inserted into the insertion portion 15 of the printing device 3. As an example of the process for setting the IC chip 1 to the reuse prohibition state, there is a process of storing, in the IC storage unit 32, control information having a content of preventing the printing device 3 from executing a predetermined process that is executed based on the information stored in the IC chip 1 (a process that can be executed by the printing device 3 based on the information when the IC chip 1 for which the reuse prohibition process (S6) is not executed is inserted) even when the IC chip 1 is inserted into the insertion portion 15. As another example of the process for setting the IC chip 1 to the reuse prohibition state, there is a process of storing, in the IC storage unit 32, control information having a content of preventing the management device 2 from acquiring the information from the IC storage unit 32, for example, by preventing the calculation unit 30 of the IC chip 1 from responding to an access from the interface 41 of the management device 2.

According to the reuse process described above, effects the same as those of the first example are obtained. According to the reuse process of the second example, even when the IC chip 1 exceeding an upper limit of the number of reuses is erroneously placed in the reuse cycle, the user can finally find the inappropriate IC chip 1. Therefore, it is possible to prevent the IC chip 1 from being reused more than the upper limit number of times.

### Third Example of Reuse Process

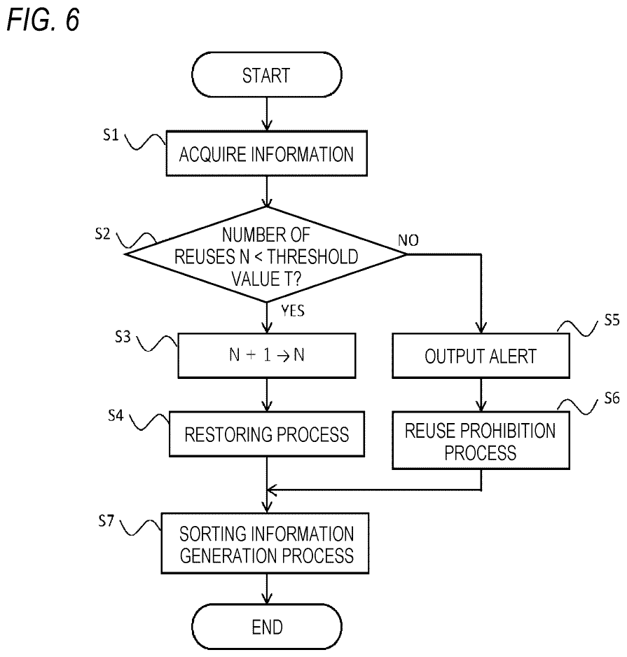

FIG. 6 is a flowchart illustrating a third example of the reuse process executed by the management device 2. The reuse process illustrated in FIG. 6 includes steps S1 to S6 that are the same as those of the reuse process (second example) illustrated in FIG. 5 and includes step S7 that is not illustrated in FIG. 5. Therefore, only matters related to step S7 will be described here.

In the reuse process in FIG. 6, a sorting information generation process (step S7) is executed on the collected IC chip 1 that has undergone the restoring process (S4) and the reuse prohibition process (S6). The “sorting” is a process of classifying the IC chips 1 into predetermined categories. For example, sorting of the IC chips 1 into a reusable IC chip 1 and an IC chip 1 prohibited from being reused, sorting that is further performed for the reusable IC chip 1 based on the number of reuses (which time the next use will be), or sorting that is further performed for the reusable IC chip 1 based on the number of reuses and a type of the consumable article, and the like are exemplified. The type of the consumable article is information on a coloring material such as ink or toner, a pretreatment liquid, a post-treatment liquid, a print head, a cleaning member, a cleaning liquid, and the like described above, and also is information including a type of color, for example, in a case of the ink.

In step S7, the sorting described above is performed for each IC chip 1 based on the number of reuses, the type of the consumable article, and the like, and sorting information indicating a sorting result is generated. The generated sorting information may be output (displayed) by the input and output device 44 of the management device 2. In this case, the operator may see the sorting information and collect the IC chip 1 in a container corresponding to the category indicated by the sorting information. A system that automatically (mechanically) collecting the IC chip 1 by the category based on the generated sorting information may be incorporated in the management device 2, or may be provided separately from the management device 2.

According to the reuse process described above, effects the same as those of the second example are obtained. According to the reuse process of the third example, the IC chip 1 can be sorted based on the number of reuses and the type of the consumable article. Therefore, the next reuse can be optimized. For example, an additional inspection may be performed according to the number of reuses. That is, for the IC chip 1 classified into the category in which the number of reuses is equal to or greater than a predetermined value, a predetermined inspection may be additionally performed to ensure the operation guarantee of the IC chip 1. Based on the type of the consumable article, the IC chip 1 may be provided to a consumable article having the same type as that of the previously used consumable article in the next reuse.

### Fourth Example of Reuse Process

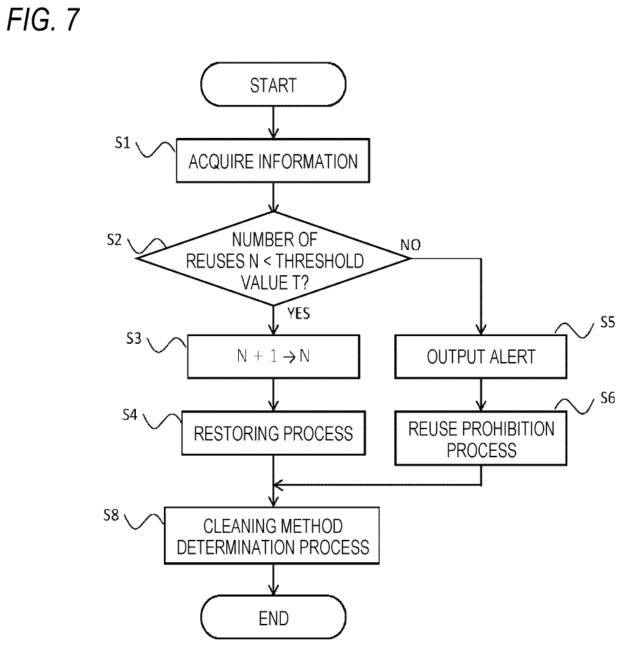

FIG. 7 is a flowchart illustrating a fourth example of the reuse process executed by the management device 2. The reuse process illustrated in FIG. 7 includes steps S1 to S6 that are the same as those of the reuse process (second example) illustrated in FIG. 5, and includes step S8 that is not shown in FIG. 5. Therefore, only matters related to step S8 will be described here.

In the reuse process in FIG. 7, a cleaning method determination process (step S8) is executed on the collected IC chip 1 that has undergone the restoring process (S4) and the reuse prohibition process (S6). For example, for the reusable IC chip 1, one cleaning method is determined from different cleaning methods based on the number of reuses. For example, it is determined that cleaning is unnecessary for the IC chip 1 that is prohibited from being reused. Here, as a cleaning method that is the cleaning method for the reusable IC chip 1 and that is different based on the number of reuses N, a method of “removing dust by an air brush” in a case of N=2, a method of “immersing in a liquid for removing dirt attached to the IC chip 1” in a case of N=3, and the like can be exemplified. The greater the number of reuses N, the longer the period of use of the IC chip 1 and the higher the possibility of substantial dirt buildup. Therefore, it is preferable to apply a more powerful cleaning method.

Such a cleaning method determination process may be performed with a content of determining the cleaning method according to the sorted classification after the sorting information generation process (S7) illustrated in FIG. 6. The cleaning method determined in the cleaning method determination process may be output (displayed) by the input and output device 44 of the management device 2. In this case, the operator may see information on the cleaning method and convey the IC chip 1 to a corresponding cleaning device. A system that automatically (mechanically) conveys the IC chip 1 to the corresponding cleaning device based on the determined cleaning method may be provided, or the cleaning device may be incorporated in the management device 2.

According to the reuse process described above, effects the same as those of the second example can be obtained. According to the reuse process of the fourth example, the cleaning method for the IC chip 1 can be determined based on the number of reuses. Therefore, appropriate cleaning can be performed according to a state (number of reuses) of the IC chip 1, and the next reuse can be optimized.

### Fifth Example of Reuse Process

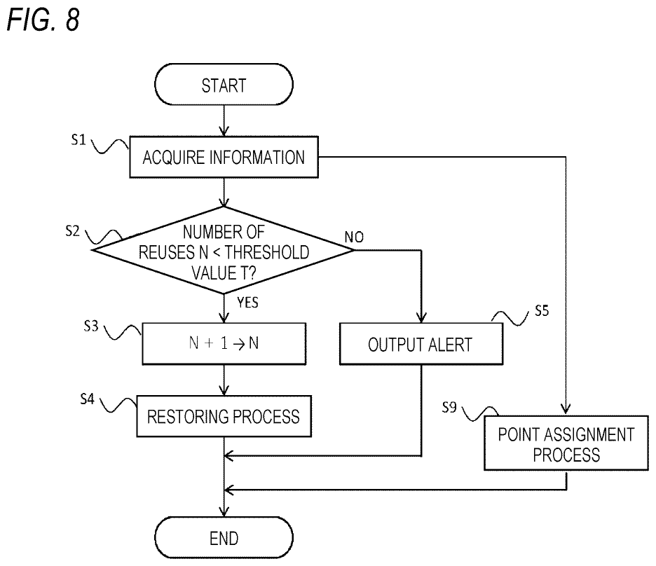

FIG. 8 is a flowchart illustrating a fifth example of the reuse process executed by the management device 2. The reuse process illustrated in FIG. 8 includes steps S1 to S5 that are the same as those of the reuse process (first example) illustrated in FIG. 4 and includes step S9 that is not illustrated in FIG. 4. Therefore, only matters related to step S9 will be described here.

In the reuse process in FIG. 8, the management device 2 acquires the predetermined information from the IC chip 1 (step S1). The information acquired here includes information on the user of the consumable article to which the IC chip 1 is attached. For example, when the user purchases a consumable article in an online store registered by the user, registered user information is stored in the IC storage unit 32, and then the IC chip 1 is attached to the consumable article and shipped to the user. When the consumable article comes to the end of its life and the IC chip 1 is collected, the management device 2 can acquire the user information from the IC chip 1 (S1). As described above, the user information acquired in step S1 includes information on the user of the consumable article provided with the IC chip 1, and also includes information on the user of the printing device 3 using the consumable article provided with the IC chip 1.

The management device 2 executes a process of assigning a predetermined point to the user information (step S9). For example, point assignment information is generated by associating the user information with the predetermined point, and the point assignment information is uploaded to the server 5 via the network 4. The server 5 stores a point accumulation value for each user based on the received point assignment information. The point accumulation value for each user may be stored in the management device 2 instead of the server 5.

According to the reuse process described above, effects the same as those of the first example are obtained. According to the reuse process of the fifth example, it is possible to store, for each user, the point accumulation value according to a purchase history (use history) of the consumable article. Therefore, it is possible to provide the user with an added value corresponding to the point accumulation value, to provide the user with an incentive to purchase a predetermined consumable article, and to provide the user with an incentive to cooperate in the collection of the IC chip 1.

Although the example of assigning the point to the user has been described above, instead of or in addition to this, a point corresponding to the number of the collected IC chips 1 may be assigned to the collection company of the IC chips 1. For example, identification information of the collection company, the number of the collected IC chips 1, and the like may be input via the input and output device 44 of the management device 2, and the predetermined point may be assigned to the collection company based on the input information. Accordingly, it is possible to provide an incentive to the collection company to cooperate in the collection of the IC chip 1.

### Others

The flowcharts illustrated in FIGS. 4 to 8 are examples. Not all of processing blocks illustrated in each flowchart are essential, and some of the processing blocks may be omitted, or other processing blocks may be added. For example, in FIGS. 5 to 7, the process of outputting the alert (step S5) may be omitted, or in FIG. 8, the reuse prohibition process (step S6) may be added in addition to or instead of the process of outputting the alert (step S5).

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

### INDUSTRIAL APPLICABILITY

The present disclosure can be applied to a management device that manages reuse of an IC chip to be provided to a consumable article.

What is claimed is:

1. A management device for an IC chip to be provided to a consumable article that is to be attached to or supplied to a printing device, the management device comprising:
a controller, wherein
the controller is configured to:
acquire information on the number of reuses of the IC chip which is stored in an IC storage included in the IC chip,
determine whether the number of reuses is equal to or greater than a predetermined number of times based on the acquired information, and
restore, in the IC storage, information obtained by counting up the number of reuses when the controller determines that the number of reuses is less than the predetermined number of times.

2. The management device according to claim 1, wherein
the controller is configured to generate sorting information on sorting for the IC chip according to the number of reuses restored in the IC storage.

3. The management device according to claim 1, wherein
the controller is configured to determine a cleaning method for the IC chip according to the number of reuses restored in the IC storage.

4. The management device according to claim 1, wherein
the controller is configured to acquire information that is stored in the IC storage and that relates to a type of the consumable article provided with the IC chip, and generates sorting information on sorting for the IC chip according to the type.

5. The management device according to claim 1, further comprising:
a storage, wherein
the controller is configured to: acquire user information on a user of the consumable article provided with the IC chip whose number of reuses is restored in the IC storage; and store the user information in the storage in association with a predetermined point.

6. The management device according to claim 1, further comprising:
a storage, wherein
the controller is configured to: acquire collector information on a collector for the IC chip whose number of reuses is stored in the IC storage; and store the collector information in the storage in association with a predetermined point.

7. The management device according to claim 1, wherein
the controller is configured to output information indicating that the number of reuses is equal to or greater than the predetermined number of times when the controller determines that the number of reuses is equal to or greater than the predetermined number of times based on the information stored in the IC storage.

8. The management device according to claim 1, wherein,
the controller is configured to store reuse prohibition information in the IC storage or sets the IC chip to a reuse prohibition state when the controller determines that the number of reuses is equal to or greater than the predetermined number of times based on the information stored in the IC storage.

9. A non-transitory computer readable storage medium storing a computer program to be executed by a computer in a management device including the computer and managing an IC chip to be provided to a consumable article that is to be attached to or supplied to a printing device, the computer program causing the computer to execute:
acquiring information on the number of reuses of the IC chip which is stored in an IC storage included in the IC chip;
determining whether the number of reuses is equal to or greater than a predetermined number of times based on the acquired information; and
restoring, in the IC storage, information obtained by counting up the number of reuses when it is determined that the number of reuses is less than the predetermined number of times.

10. A printing consumable article management IC chip comprising:
a calculator and an IC storage, wherein
the printing consumable article management IC chip is provided to a consumable article that is to be attached to or supplied to a printing device, and the IC storage stores information on the number of reuses of the calculator.
